(19) United States
(12) Patent Application Publication
(10) Pub. No.: US 2005/0000987 A1
(43) Pub. Date: Jan. 6, 2005

(54) Golf bag support bracket

(76) Inventor: David C. Heidenreich, Franklin, TN (US)

Correspondence Address: Steven Thrasher, 391 Sandhill Dr., Richardson, TX, 75080, US

(21) Appl. No.: 10/891,530

(22) Filed: Jul. 15, 2004

Related U.S. Application Data
(63) Continuation-in-part of application No. 10/452,351, filed on Jun. 2, 2003.

(51) Int. Cl. B60R 9/00; A63B 55/04; A63B 55/06; A63B 55/00

(52) U.S. Cl. 224/274; 206/315.7

(57) ABSTRACT

The invention teaches an apparatus and method for using an apparatus that provides a golf bag at an angle from an upright position on a motorized golf. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims. 37 CFR 1.72(b).

This is a continuation-in-part application of copending application Ser. No. 10/452,351, entitled, Angled Presentation Golf Bag, filed on Jun. 2, 2003, which is hereby incorporated by reference, in accordance with 35 U.S.C. 120.

### TECHNICAL FIELD OF THE INVENTION

The invention relates generally to golfing and, more particularly, to a golf bag support equipment.

### PROBLEM STATEMENT

Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

Discussion

Some golfers walk while other golfers ride motorized golf carts. Indeed many golfers are unable to walk for a complete round and so must always ride. Some golf courses actually require that golfers ride, at least in part, because of the revenue generated by motorized golf cart rental.

Traditionally, golf bags have been suited for either a golfer who carries clubs himself; or for the golfer who uses a motorized golf cart. Unfortunately, using either type of golf bag for use on a motorized golf cart presents problems for many golfers. Typically, cart mounting renders the golf bag in a complete upright position. The upright position combined with the length of the typical golf club makes it difficult to remove and/or replace a club to the bag.

More specifically, golf carts are commonly equipped with a low deck area on the back of the cart where the bottom of the golf bags may be placed. A rigid horizontal support for securing golf bags to the golf cart is commonly provided on the rear of the golf cart. The horizontal support typically includes flexible straps for looping around the golf bag for securing the golf bag against the horizontal support in a conventional manner.

Although the conventional system of a flexible strap and horizontal support does hold the golf bag securely while the golf cart is in motion, the golf bag and clubs contained inside are held in a mostly upright position making it more difficult to retrieve and replace the clubs.

There is a need for a more efficient and/or effective means of attaching golf bags to golf carts which address problems such as the above described.

### BRIEF DESCRIPTION OF THE DRAWINGS

Various aspects of the invention, as well as an embodiment, are better understood by reference to the following detailed description. To better understand the invention, the detailed description should be read in conjunction with the drawings in which:

FIG. 1 shows a preferred embodiment of an angled presentation golf bag resting on the rear of a motorized golf cart;

FIG. 2 illustrates a side view of an angled presentation golf bag;

FIG. 3 illustrates the details of an angle θ;

FIG. 4 is a top-down view of the angled presentation golf bag;

FIG. 5 illustrates another golf bag support device in accordance with exemplary embodiments of the present invention; and

FIG. 6 illustrates the support device of FIG. 5 for use with a conventional motorized golf cart bag attachment system.

### EXEMPLARY EMBODIMENT OF A BEST MODE

Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for—functioning—” or “step for—functioning—” in the claims section. Sixth, the invention is also described in view of the Festo decisions, and, in that regard, the claims and the invention incorporate equivalents known, foreseeable, and unforeseeable. Seventh, the language and each word used in the invention should be given the ordinary interpretation of the language and the word, unless indicated otherwise. It should be noted in the following discussion that acts with like names are performed in like manners, unless otherwise stated. Of course, the foregoing discussions and definitions are provided for clarification purposes and are not limiting. Words and phrases are to be given their ordinary plain meaning unless indicated otherwise. Further, indications of orientation are not to be given absolute interpretation with respect to a fixed origin or axis, but are rather provided to give general reference orientations with respect to other provided general orientations.

### DESCRIPTION OF THE DRAWINGS

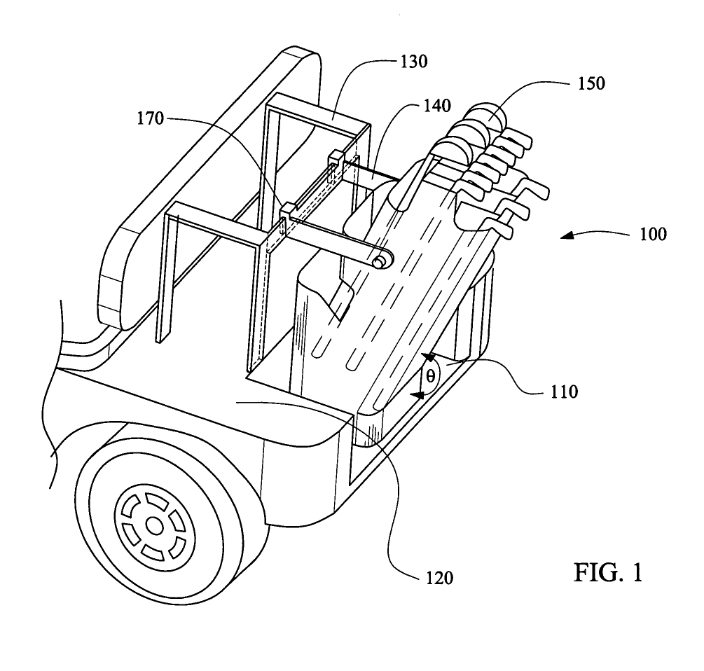

Features and advantages of the invention can be better understood by reviewing FIG. 1, which illustrates a side view of an angled presentation golf bag 100 resting on a motorized golf cart 120 which provides a supporting member 110. The supporting member 110 is any golf cart surface that is adapted to support a golf bag, and could be a metal plate or molded plastic support, for example. In one embodiment, the angled presentation golf bag 100 is bent at an angle θ (defined below) to present a golf club 150 to a golfer.

In one embodiment, a securing means shown here as an armature 140 provides a coupling member (shown in FIG. 1 as a notch 170) that allows the golf bag 100 to secure to the golf cart 120 via a supporting member 130. The notch 170 may be rectangular, arched, or irregular in shape, for example. In alternative embodiments, the securing means 140 of the angled presentation golf bag 100 could be secured to the securing member 130 of a motorized golf cart 120 via a coupling member such as a clip, clamp, golf club holder, or belt, for example. Additionally, a belt (not shown) may be used to directly secure the angled presentation golf bag 100 to the securing member 130 of a motorized golf cart 120. In another embodiment, a belt could be used to directly secure the angled presentation golf bag 100 to the supporting member 110 of a motorized golf cart 120.

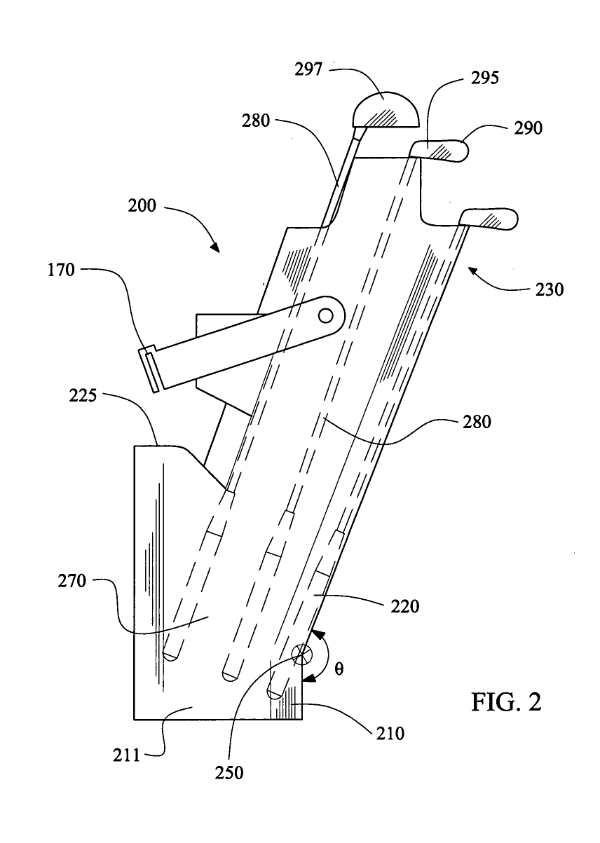

FIG. 2 illustrates an alternative embodiment of a side view of an angled presentation golf bag 200. The angled presentation golf bag 200 comprises a base 210, a body 220, a top (generally) 230. The golf bag base 210 is comprised of a substantially vertical hollow column 211 that is coupled to the golf bag body 220 a body base coupling point 250. Of course, the body base coupling point 250 may be defined by any form of coupling, and in the event that the base and the body are integrally formed, the body base coupling 250 is merely the location of coupling. In one embodiment, a flexible coupling may be adapted between the base 210 and the body 220 to allow the angle θ to be adjustable by a user, such as a golfer, or caddy, for example.

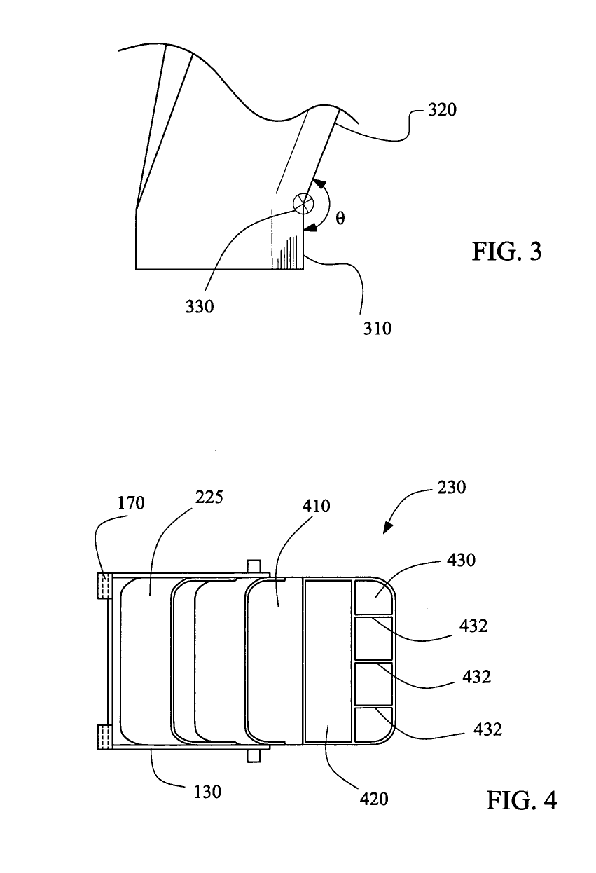

The angle θ makes golf clubs more easily accessible to a golfer from the rear of a motorized golf cart. The angle θ is formed by the intersection of the external vertical base wall 310 and a generally vertical body wall 320 at the body base coupling point 250 (such as that shown in FIG. 3). Note that in one embodiment, the angle θ may vary along the width of the bag 200 (such as that shown in FIG. 2).

The body 230 contains a cavity 270 for accepting a least one golf club shaft 280. In a preferred embodiment, the cavity 270 extends from the body 220, through the body base coupling 250, and to the golf bag top 230. The golf bag top 230 is preferably adapted for at least one golf club holder (not shown). A golf club holder is any device that secures golf clubs within the cavity 270.

In one embodiment, a least one golf club 290, such as an iron, for example, could hang outside the golf bag 200, inverted by its golf club head 295, with its shaft 280 hanging within the continuous cavity 270 and into the substantially vertical hollow column 211. In an alternative embodiment at least one golf club 297, such as a wood, for example could be tightly secured by its golf club shaft 280, to a golf club holder 240, with the golf club shaft 280 suspended within the continuous cavity 270. Alternatively, a wood (or other club) may extend completely to the bottom of the bag. In one embodiment, a golf club shaft 280 may be parallel with a golf bag external body wall. In an alternative embodiment, a golf club shaft 280 may be non-parallel with a golf bag's external body wall.

In one embodiment, a golf accessory pocket 225 may be coupled to the posterior side of an angled presentation golf bag 200. In an alternative embodiment, accessory pockets (not shown) could be placed on the anterior side of an angled presentation golf bag 200. Other alternative embodiments may have accessory pockets on the side of an angled presentation golf bag 200. However, this configuration could complicate placing two angled presentation golf bags 200 on the same golf cart side by side, especially when the accessory pockets are full. In one embodiment, an armature and/or bag may be adapted to enable a bag to lean or swing to more advantageously expose a bag, such as a golf ball bag.

FIG. 3 illustrates details of an angle θ that is formed by the intersection of the external vertical base wall 310 and the generally vertical body wall 320 at the body base coupling point 330. The external base wall 310 descends from the body base coupling point 330 to the lower most portion of a golf bag. The external body wall ascends 320 from the body base coupling point 330 to the upper most portion or top of the golf bag. The body base coupling point 330 is that the origin of the angle θ. The angle θ is greater than 90 degrees and less than 180 degrees. In one embodiment, the angle θ is greater than 90 degrees and less than 170 degrees. In an alternative embodiment, the angle θ may be greater than 150 degrees and less than 170 degrees, or, the angle θ may be greater than 155 degrees and less than 165 degrees. In a preferred embodiment, the angle θ may be adjustable to a desired presentation.

FIG. 4 is a top-down view of the angled presentation golf bag top 230. From this view, one sees that a cavity may be segmented into a plurality of sections 410, 420, 430. In one embodiment, the cavity is segmented generally into three sections, a first section 410 for holding wood-clubs, a second section 420 that is adapted to accept a golf club holder, and third section that is adapted to carry woods, a wedge, a gap wedge, and/or sand wedge, in a non-destructive configuration by using dividers to keep wood golf clubs separated from each-other. Of course, it is understood that a wood is defined by a driving function, and not by a literal “wood” content. In one embodiment, three dividers 432 are used, and in a preferred embodiment, four dividers 432 are used to separate the third section 430 into five sections. This allows for two dividers to separate wedges, and two dividers to keep wedges from interfering with pockets that are on the sides of the golf bag. In one embodiment, when the wedges are not used, such as when the bag is in transport, wedges detach from magnets and rest in the space defined by the dividers 432 so that a cover may be placed over wedges.

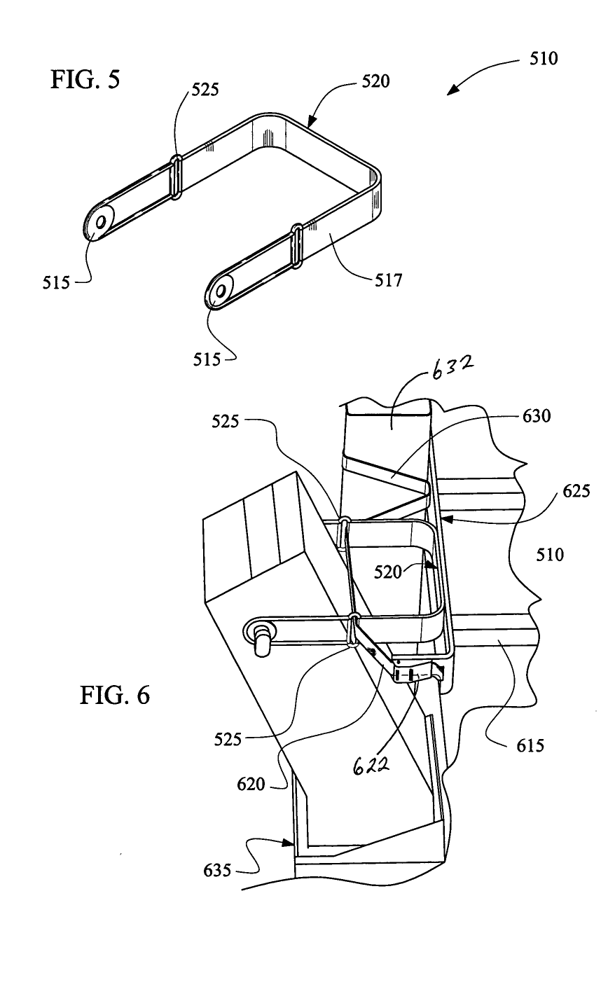

As shown in FIGS. 5 and 6, one embodiment of the present invention enables attachment of a golf bag 200 to couple to a motorized golf cart 120, using conventional bag attachment equipment found on most motorized golf carts, for presenting golf clubs at a more desirable angle to a golfer.

More specifically, FIG. 5 illustrates a prospective view of an armature 510 for coupling a golf bag to a motorized golf cart. In one embodiment, the armature 510 includes golf bag coupling members 515 at a proximal end, a support portion 520 at a distal end, and a pair of guide portions here illustrated as strap guides 525 located on the arms 517 between the golf bag coupling members 515 and the support portion 520. Preferably, the strap guides 525 are located at a distance closer to the bag coupling 515 and further from the support back 520 for increasing the stability of the attachment arrangement. In an alternative embodiment, a single arm may be employed, or an armature may comprise a “T” structure. Alternatively, a small hook or clamp may be located on top of the armature support portion 520 to assist a golfer with securing a golf bag to a golf cart as will be readily understood by one of ordinary skill in the art upon reading this disclosure. Preferably, the hook is a small single rod hook no more than one inch higher than the armature position. The hook can insure that the armature does not fall below the support bracket of the golf cart support, and more rigidly secure the golf bag to the golf cart.

The arms 517 are generally parallel to each other and spaced apart at approximately the width of a golf bag. Of course, other arm configurations are applicable to provide rigid and reliable support, as is known in the mechanical framing arts. Further, the arms 517 are preferably formed of a rigid material such as metal, but may also be formed of other suitable rigid materials such as plastics, nylon, or composite materials, for example.

The bag coupling members 515 are for engaging the outer portion of the golf bag. As shown in the present embodiment, the bag coupling members 515 are a pair of circular pivot portions (such as a conventional washer) configured to receive a shaft or pivot member associated with the golf bag. For example, a golf bag configured with threaded studs extending outwardly can be secured via the bag coupling members 515 using a nut or other similar device. Alternatively, in one embodiment coupling members 515 are adapted to couple to a prior art golf bag such that the prior art golf bag may provide an angled presentation. The bag coupling members 515 are preferably pivotal in nature to enable the armature 510 to swivel about the bag attachment point. Thus, when attached to the golf bag, the armature 510 can easily be lowered to the golf bag's side when not in use with the golf cart. Though the bag coupling member 515 is described with respect to a specific preferred embodiment, it is only one example that could be used to connect the armature 510 with the golf bag, any suitable connecting mechanism known or foreseeable may be used for this purpose, and will be obvious to one of ordinary skill in the art upon reading the present disclosure. The bag coupling member 515 may also be adapted such that the armature may removably attach/detach from a golf cart (such as when a golfer wishes to walk with/carry the bag). The armature may also be of a sufficient length to “swing” over the golf bag such that it provides a second functionality as a handle for either carrying the golf bag by hand, or rolling the golf bag on wheels. Additionally, the armature may lock or secure a top/lid on the golf bag to adapt the golf bag for airport/airplane transportation.

Referring now to FIG. 6 there is shown the armature 510 in use with a conventional bag attachment structure employed on a motorized golf cart. The conventional attachment structure includes a rigid horizontal support 625 and a flexible strap 620 with associated buckle. Conventionally, the strap 620 is wrapped around a golf bag and winched via the buckle to secure the golf bag against the horizontal support 625 (a conventional attachment is shown at item 630). Note that such a conventional attachment secures a golf bag 632 in a substantially upright position.

In accordance with embodiments of the present invention, the armature 510 is secured to the horizontal support 625 by threading the strap 620 through the strap guides 525 and into the buckle 622. The support back 520 of the armature 510 is positioned adjacent to the horizontal support 625 and the strap 620 is winched tightly via the buckle to secure the armature 510 with the arms 517 extending horizontally and perpendicular from the horizontal support 625. With the armature 510 secured, the bottom of an attached golf bag rests on the golf cart low deck 635 and the top portion of the golf bag is tilted away from the golf cart presenting the golf clubs to the golfer at an angle (hereinafter referred to as the presentation angle) from the upright position.

As can be seen from FIG. 6, the presentation angle is in part a function of the length of the armature arms 517. The armature arms 517 may include an adjustable length portion (not shown) for extending the length of the arms 517, thus enabling slight adjustments to be made to accommodate golf bags of varying height, varying angles of presentation, and golf carts with varying distances from the horizontal support 625 to the low deck 635. Such application should be readily apparent to one of ordinary skill in the art upon reading the invention, and the invention is to be read to include all such extending means known, foreseeable, and unknown. In addition to providing a more desirable angle of presentation, using the armature 510 can position the top portion of the golf bag closer to the ground (as compared to the bag being held in an upright position) which further improves retrievability and replacability.

In another embodiment, the armature 510 can be an integral part of the horizontal support 625. In this embodiment, the flexible strap 620 and associated buckle are not needed. The horizontal support 625 would appear to have a pair of arms 517 extending there from with a bag coupling member 515 coupled to each extended arm end. In this configuration, the arm 517 may extend outwardly from the back of the golf cart horizontally with respect to the ground or may extend downwardly toward the ground.

Though the invention has been described with respect to a specific preferred embodiment, many variations and modifications will become apparent to those skilled in the art upon reading the present application. It is therefore the intention that the appended claims and their equivalents be interpreted as broadly as possible in view of the prior art to include all such variations and modifications.

1. An apparatus for securing a golf bag at an angle from an upright position on a motorized golf cart which comprises a low deck, a horizontal support fixed above the low deck, and a strapping mechanism coupled with said horizontal support, the apparatus comprising:
a support portion;
at least one arm coupled to the support portion at a first end and adapted to extend substantially perpendicularly therefrom; and
a coupling member portion for the at least one arm, the coupling member portion being proximately the end opposite the first end, and adapted for coupling to a golf bag.

2. The apparatus of claim 1 further comprising a guide portion on the at least one arm, the guide portion being adapted for receiving a flexible strap of the strapping mechanism for adjustably securing the base adjacent to the horizontal support.

3. The apparatus of claim 1 wherein the support portion is adapted to rigidly couple to a golf cart horizontal support.

4. The apparatus of claim 1 wherein the coupling member comprises a pivot-type coupling for pivotally coupling the arm to the golf bag.

5. The apparatus of claim 4 wherein said coupling member comprises a generally circular opening adapted for receiving one of a bolt and a stud.

6. The apparatus of claim 1 wherein said base and arms are made from a metal material.

7. The apparatus of claim 1 wherein the at least one arm is of a length such that a bottom portion of said golf bag rests on the low deck, and a top portion of the golf bag extends away from the golf cart when the golf bag is coupled with the coupling member and the support portion is secured to the horizontal support.

8. The apparatus of claim 7 wherein the at least one arm is extendable via an adjustable length portion.

9. The apparatus of claim 1 further comprising a second arm, and wherein the arms are adapted to extend from the support portion in an approximately parallel relationship to one another.

10. A system for securing a golf bag at an angle from an upright position on a motorized golf cart, said system comprising:
a low deck connectable with a rear portion of a motorized golf cart; and
a horizontal support connectable with a rear portion of the motorized golf cart above the low deck such that the golf bag may rest on the low deck while being engaged with the horizontal support, the horizontal support comprising:
a support portion;
at least one arm coupled to the support portion at a first end and adapted to extend substantially perpendicularly therefrom; and
a coupling member portion for the at least one arm, the coupling member portion being proximately the end opposite the first end, and adapted for coupling to a golf bag.

11. The system of claim 10 wherein said coupling member comprises a pivot type coupling for pivotally connecting the golf bag to the at least one arm.

12. The system of claim 10 wherein said coupling member comprises a circular opening adapted for receiving a bolt.

13. The system of claim 10 wherein said arms are made from a nylon material.

14. The system of claim 10 wherein the at least one arm is of a length such that a bottom portion of the golf bag rests on the low deck, and a top portion of the golf bag extends away from the golf cart when the golf bag is coupled with the coupling member.

15. The apparatus of claim 10 further comprising a guide portion on the at least one arm, the guide portion being adapted for receiving a flexible strap of the strapping mechanism for adjustably securing the base adjacent to the horizontal support.

16. The system of claim 10 further comprising a second arm, and wherein the arms are adapted to extend from the support portion in an approximately parallel relationship to one another.

17. An apparatus for securing an angle presentation golf bag on a motorized golf cart which comprises a low deck, a horizontal support fixed above the low deck, wherein a bottom of the angle presentation golf bag is adapted to sit on the low deck, said apparatus comprising:
a support portion;
at least one arm coupled to the support portion at a first end and extending substantially perpendicular therefrom;
means for coupling said at least one arm to a golf bag; and
means for securing the support portion adjacent to a horizontal support.

18. The apparatus of claim 17 further comprising a second arm, wherein the arms are of a length such that a bottom portion of the golf bag rest on the low deck and a top portion of the golf bag extends at an angle from an upright position away from the golf cart when the golf bag is coupled with the coupling member.
